(19) United States
(12) Patent Application Publication
(10) Pub. No.: US 2023/0387704 A1
(43) Pub. Date: Nov. 30, 2023

(54) Taser Charging Dock Device

(71) Applicants: Matt Christopher, South Dayton, NY (US); Thomas Rozumalski, Dunkirk, NY (US)

(72) Inventors: Matt Christopher, South Dayton, NY (US); Thomas Rozumalski, Dunkirk, NY (US)

(21) Appl. No.: 18/319,027

(22) Filed: May 17, 2023

Related U.S. Application Data
(60) Provisional application No. 63/345,508, filed on May 25, 2022.

(51) Int. Cl. H02J 7/00

(52) U.S. Cl. CPC H02J 7/0045; H02J 7/0013; F41H 13/0012

(57) ABSTRACT

A taser charging dock device is disclosed that comprises a base component with at least ten individual taser slots for holding up to ten tasers and their respective charging cords within the slots on the dock device. The base component comprises internal wiring, such as a 10-port USB strip to accommodate the tasers and their charging cords hidden within the base component. Users can plug the entire dock device into a wall outlet to charge up to ten tasers simultaneously within the individual slots. The device keeps multiple tasers organized and fully charged for quick and easy access.

### CROSS-REFERENCE TO RELATED APPLICATION

The present application claims priority to, and the benefit of, U.S. Provisional Application No. 63/345,508, which was filed on May 25, 2022, and is incorporated herein by reference in its entirety.

### FIELD OF THE INVENTION

The present invention relates generally to the field of taser charging dock devices. More specifically, the present invention relates to an improved storing and charging unit for law enforcement tasers. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in taser charging dock devices. Generally, law enforcement agencies may lack proper charging and storage areas for their tasers. If an officer takes an uncharged taser and needs to deploy it out in the field, he/she may be put in danger if they are unable to do so due to a dead battery. Further, tasers may be thrown in a drawer and become messy and disorganized for officers looking for a taser.

Currently, with the rapid development of science and technology, more and more electronic products are developed and in need of charging. However, a traditional charging dock is only adapted for charging a single hand-held device. Generally, especially with regards to employment offices, such as a police station, etc., a user needs multiple hand-held devices charged simultaneously.

Accordingly, there is a demand for an improved taser charging dock device that can charge multiple tasers simultaneously. More particularly, there is a demand for a charging dock that also acts to store multiple tasers while not in use.

Therefore, there exists a long-felt need in the art for a taser charging dock device that provides users with an improved storing and charging unit for law enforcement tasers. There is also a long-felt need in the art for a taser charging dock device that includes ten individual taser slots that can support a taser and its respective charging cord. Further, there is a long-felt need in the art for a taser charging dock device that can be modified to accommodate any brand or model of law enforcement taser. Moreover, there is a long-felt need in the art for a device that keeps tasers neatly stored and easily accessible, ensuring law enforcement officers can quickly grab a fully charged taser. Further, there is a long-felt need in the art for a taser charging dock device that reduces clutter in a police station while preventing officers from taking uncharged tasers from a storage area. Finally, there is a long-felt need in the art for a taser charging dock device that can be constructed of durable plastic.

The subject matter disclosed and claimed herein, in one embodiment thereof, comprises a taser charging dock device. The device is a specialized storage stand and charging dock for multiple police-issued tasers. The taser charging dock device comprises a base component with at least ten individual taser slots for holding up to ten tasers and their respective charging cords within the slots on the dock device. The base component comprises internal wiring, such as a 10-port USB strip, to accommodate the tasers and their charging cords hidden within the base component. Users can plug the entire dock device into a wall outlet to charge up to ten tasers simultaneously within the individual slots. The device can be constructed of a strong, durable plastic material that makes sanitizing simple and safe. The device keeps multiple tasers organized and fully charged for quick and easy access.

In this manner, the taser charging dock device of the present invention accomplishes all of the foregoing objectives and provides users with a device that fully charges and stores multiple tasers. The device is a base component with multiple slots for holding tasers. The device can be manufactured of a plastic material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a taser charging dock device. The device is a specialized storage stand and charging dock for multiple police-issued tasers or other electronic weapons. The taser charging dock device comprises a base component with at least ten individual taser slots or apertures for holding up to ten tasers and their respective charging cords within the slots on the dock device. The base component comprises internal wiring, such as a 10-port USB strip, to accommodate the tasers and their charging cords hidden within the base component. Users can plug the entire dock device into a wall outlet to charge up to ten tasers simultaneously within the individual slots. The device keeps multiple tasers organized and fully charged for quick and easy access.

In one embodiment, the taser charging dock device is adapted for charging or storing at least one hand-held electronic weapon, such as a taser, a stun gun, an electroshock weapon, etc., or other suitable electronic defense weapons as is known in the art. Generally, the taser charging dock device comprises a base component with a plurality of slots.

In one embodiment, the taser charging device comprises a base component that is a dock for receiving a plurality of electronic weapons, including at least one support coupled to an inner wall of the base component for supporting the electronic weapons in an upright position. Generally, the supports and inner walls create a slot for retaining the electronic weapons. In another embodiment, instead of slots, the base component comprises a plurality of shallow apertures or blind holes that are sized and shaped to retain the handle of the electronic weapons for charging. Further, the electronic weapons are stored within the base component and their charging cords are hidden within the base component slots or apertures.

In one embodiment, the base component is sized and shaped to receive a plurality of electronic weapons. In one example, the base component comprises a plurality of supports and an inner wall for receiving the plurality of electronic weapons. In general, the supports and inner walls support the weight of a received electronic weapon. Typically, the size and shape of the supports and inner walls may be selected to accommodate different sizes and types of electronic weapons.

In one embodiment, the plurality of slots comprise a charging connector component which contacts the mating connector of the electronic weapon to charge the weapon. The charging connector component can be any suitable connector as is known in the art, such as a USB port, a magnetic force contact, etc., or any other suitable connecting means as is known in the art for charging the electronic weapons. In one embodiment, the charging connector component is a 10-port USB strip to accommodate all of the electronic weapons simultaneously.

Further, the charging connector component is typically positioned within the slots, between the supports and inner walls of the base component or through the plurality of shallow apertures of the base component. The charging connector components are movable relative to the base component and can be positioned in other positions on the base component for charging the electronic weapons, based on the needs and/or wants of a user. Generally, the charging connector components are in electrical communication with a power source. The power source can comprise an electrical plug that can be plugged into a wall outlet to charge the base component. Further, the power source can comprise a battery, a rechargeable battery, etc., which would act to power the base component. Once the base component is powered, the plurality of electronic weapons can then be simultaneously charged on the taser charging dock device.

In one embodiment, the power source can be one or more rechargeable batteries or a port to an external power supply which powers the taser charging dock device. Further, components electrically communicate with one another when the electrical activity in one component affects an electrical activity in another. Electrical communication includes direct electrical contact that enables current flow. The base component may include one or more charging connector components for electrically communicating with the mating connectors of the electronic weapons. In one embodiment, wiring extends from the charging connectors for electrically communicating with a power supply, such as an electrical outlet, for example.

In one embodiment, the base component may be manufactured of molded plastic, machined metal, wood, etc., for any other suitable materials as is known in the art. The device, constructed of a strong, durable plastic material, makes sanitizing simple and safe. Further, the base component may be manufactured as a single integral part or may be an assembly of multiple parts secured together.

In operation, a user places the electronic weapons in the base component of the taser charging dock device for charging. The electronic weapons are then engaged with the charging connector components of the base component to charge the electronic weapons. The base component can then be plugged into a wall receptacle to allow the electronic weapons to charge simultaneously.

In yet another embodiment, the taser charging dock device comprises a plurality of indicia.

In yet another embodiment, a method of storing and charging multiple tasers simultaneously is disclosed. The method includes the steps of providing a taser charging dock device comprising a base component with multiple slots for holding tasers and their respective charging cords. The method also comprises inserting a wall receptacle plug on the device into a wall outlet to power the device. Further, the method comprises positioning multiple tasers within the multiple slots. The method comprises plugging in the tasers via their respective charging cords to a USB port on the device. Finally, the method comprises charging and storing the multiple tasers in the device.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the taser charging dock device of the present invention showing the device in use in accordance with the disclosed architecture;

FIG. 2 illustrates a perspective view of one embodiment of the taser charging dock device of the present invention showing multiple tasers stored and charged within the device in accordance with the disclosed architecture; and

FIG. 3 illustrates a flowchart showing the method of storing and charging multiple tasers simultaneously in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a taser charging dock device that provides users with an improved storing and charging unit for law enforcement tasers. There is also a long-felt need in the art for a taser charging dock device that includes ten individual taser slots that can support a taser and its respective charging cord. Further, there is a long-felt need in the art for a taser charging dock device that can be modified to accommodate any brand or model of law enforcement taser. Moreover, there is a long-felt need in the art for a device that keeps tasers neatly stored and easily accessible, ensuring law enforcement officers can quickly grab a fully charged taser. Further, there is a long-felt need in the art for a taser charging dock device that reduces clutter in a police station while preventing officers from taking uncharged tasers from a storage area. Finally, there is a long-felt need in the art for a taser charging dock device that can be constructed of durable plastic.

The present invention, in one exemplary embodiment, is a novel taser charging dock device. The taser charging dock device comprises a base component with at least ten individual taser slots for holding up to ten tasers and their respective charging cords within the slots on the dock device. The base component comprises internal wiring, such as a 10-port USB strip, to accommodate the tasers and their charging cords hidden within the base component. Users can plug the entire dock device into a wall outlet to charge up to ten tasers simultaneously within the individual slots. The device keeps multiple tasers organized and fully charged for quick and easy access. The present invention also includes a novel method of storing and charging multiple tasers simultaneously. The method includes the steps of providing a taser charging dock device comprising a base component with multiple slots for holding tasers and their respective charging cords. The method also comprises inserting a wall receptacle plug on the device into a wall outlet to power the device. Further, the method comprises positioning multiple tasers within the multiple slots. The method comprises plugging in the tasers via their respective charging cords to a USB port on the device. Finally, the method comprises charging and storing the multiple tasers in the device.

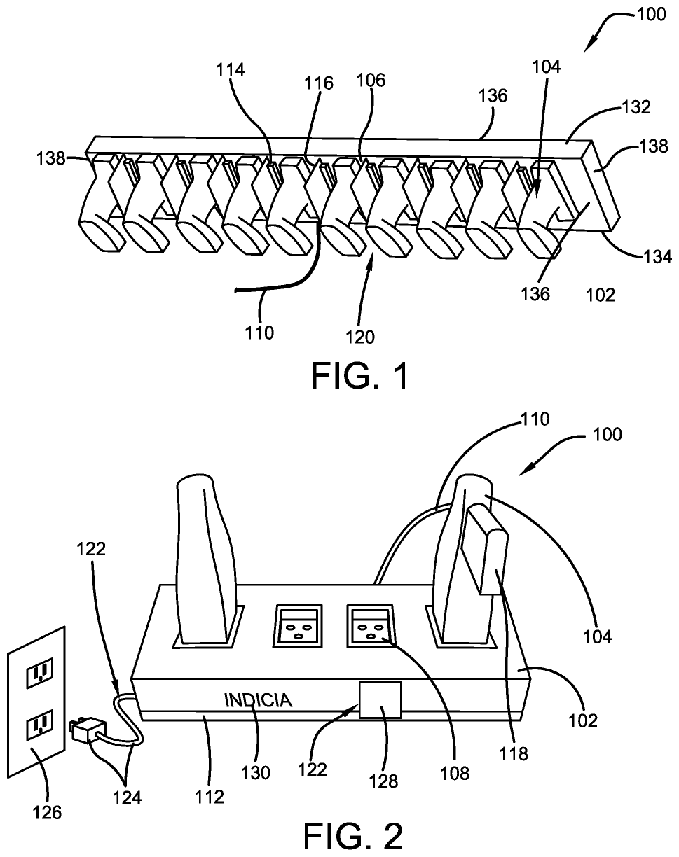

Referring initially to the drawings, FIGS. 1-2 illustrate a perspective view of one embodiment of the taser charging dock device 100 of the present invention. In the present embodiment, the taser charging dock device 100 is an improved taser charging dock device 100 that provides a user with a specialized storage stand and charging dock for multiple police-issued tasers or other electronic weapons 104. Specifically, the taser charging dock device 100 comprises a base component 102 with a plurality of slots 106 or apertures 108 for holding up to ten tasers or other electronic weapons 104 and their respective charging cords 110 for storage and charging. The base component 102 comprises internal wiring, such as a 10-port USB strip 112, to accommodate the electronic weapons 104 and their charging cords 110 hidden within the base component 102. Users can plug the entire dock device 100 into a wall outlet 112 to charge up to ten electronic weapons 104 simultaneously within the individual slots 106/apertures 108. The device 100 keeps multiple electronic weapons 104 organized and fully charged for quick and easy access.

Generally, the taser charging dock device 100 is adapted for charging or storing at least one hand-held electronic weapon 104, such as a taser, a stun gun, an electroshock weapon, etc., or other suitable electronic defense weapons as is known in the art. Further, any suitable electronic device can be charged on the taser charging dock device 100, such as a radio, a smart phone, a laptop, etc.

Furthermore, the taser charging dock device 100 comprises a base component 102 that is a dock for receiving a plurality of electronic weapons 104. The base component 102 is generally rectangular in shape but can be any suitable size and shape as is known in the art. The base component 102 comprises a top surface 132, a bottom surface 134, opposing front and back sides 136, and opposing right and left sides 138. Further, the base component 102 comprises at least one support 114 coupled to an inner wall 116 of the base component 102 for supporting the electronic weapons 104 in an upright position. Generally, the supports 114 and inner walls 116 create a slot 106 for retaining the electronic weapons 104. In another embodiment, instead of slots 106, the base component 102 comprises a plurality of shallow apertures 108 or blind holes that are sized and shaped to retain the handle 118 of the electronic weapons 104 for charging. Specifically, the handle 118 of the electronic weapons 104 are nested within the apertures 108 to retain the weapons 104 on the base component 102. Further, the electronic weapons 104 are stored within the base component 102 and their charging cords 110 are hidden within the base component 102 slots 106 or apertures 108.

Accordingly, the base component 102 is sized and shaped to receive a plurality of electronic weapons 104. In one example, the base component 102 comprises a plurality of supports 114 and an inner wall 116 for receiving the plurality of electronic weapons 104. In general, the supports 114 and inner walls 116 support the weight of a received electronic weapon 104. Typically, the size and shape of the supports 114 and inner wall 116 may be selected to accommodate different sizes and types of electronic weapons 104. Further, the base component 102 can be sized and shaped to charge multiple electronic weapons 104 or can be sized and shaped to charge only one electronic weapon 104.

In one embodiment, the plurality of slots 106 comprise a charging connector component 120 which contacts the mating connector (i.e., charging cords 110) of the electronic weapon 104 to charge the weapon 104. The charging connector component 120 can be any suitable connector as is known in the art, such as a USB port, a magnetic force contact, etc., or any other suitable connecting means as is known in the art for charging the electronic weapons 104. In one embodiment, the charging connector component 120 is a 10-port USB strip to accommodate all of the electronic weapons 104 simultaneously.

Further, the charging connector component 120 is typically positioned within the slots 106 between the supports 114 and inner walls 116 of the base component 102 or through the plurality of shallow apertures 108 of the base component 102. The charging connector components 120 are movable relative to the base component 102 and can be positioned in other positions on the base component 102 for charging the electronic weapons 104, based on the needs and/or wants of a user. Generally, the charging connector components 120 are in electrical communication with a power source 122. The power source 122 can comprise an electrical plug 124 that can be plugged into a wall outlet 126 to charge the base component 102. Further, the power source 122 can comprise a battery 128, a rechargeable battery, etc., which would act to power the base component 102. Once the base component 102 is powered, the plurality of electronic weapons 104 can then be simultaneously charged on the taser charging dock device 100.

Generally, the power source 122 can be one or more rechargeable batteries 128 or a port or electrical plug 124 to an external power supply (i.e., wall outlet 126) which powers the taser charging dock device 100. Further, components electrically communicate with one another when the electrical activity in one component affects an electrical activity in another. Electrical communication includes direct electrical contact that enables current flow. Accordingly, the base component 102 may include one or more charging connector components 120 for electrically communicating with the mating connectors (i.e., charging cords 110) of the electronic weapons 104. In one embodiment, wiring extends from the charging connector components 120 for electrically communicating with a power supply 122, such as an electrical outlet 126, for example.

The battery 128 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the taser charging dock device 100. Throughout this specification, the term “battery” may be used interchangeably to refer to one or more wet or dry cells or batteries of cells in which chemical energy is converted into electricity and used as a source of DC power. References to recharging or replacing the battery 128 may refer to recharging or replacing individual cells, individual batteries of cells, or a package of multiple battery cells as is appropriate for any given battery technology that may be used. In addition, a rechargeable embodiment of the battery 128 may be recharged using a USB port (not shown), wherein the USB port is a USB-A, USB-B, Micro-B, Micro-USB, Mini-USB, or USB-C port, etc.

Furthermore, the base component 102 may be manufactured of molded plastic, machined metal, wood, etc., or any other suitable materials as is known in the art. The device 100, constructed of a strong, durable plastic material, makes sanitizing simple and safe. Further, the base component 102 may be manufactured as a single integral part or may be an assembly of multiple parts secured together.

In operation, a user places the electronic weapons 104 in the base component 102 of the taser charging dock device 100 for charging. The electronic weapons 104 are then engaged with the charging connector components 120 of the base component 102 to charge the electronic weapons 104. The base component 102 can then be plugged into a wall receptacle 126 to allow all of the electronic weapons 104 to charge simultaneously.

In one embodiment, the taser charging dock device 100 comprises a plurality of indicia 130. The base component 102 of the device 100 may include advertising, trademark, other letters, designs, or characters, printed, painted, stamped, or integrated into the base component 102, or any other indicia 130 as is known in the art. Specifically, any suitable indicia 130 as is known in the art can be included, such as, but not limited to, patterns, logos, emblems, images, symbols, designs, letters, words, characters, animals, advertisements, brands, etc., that may or may not be taser, charging, or brand related.

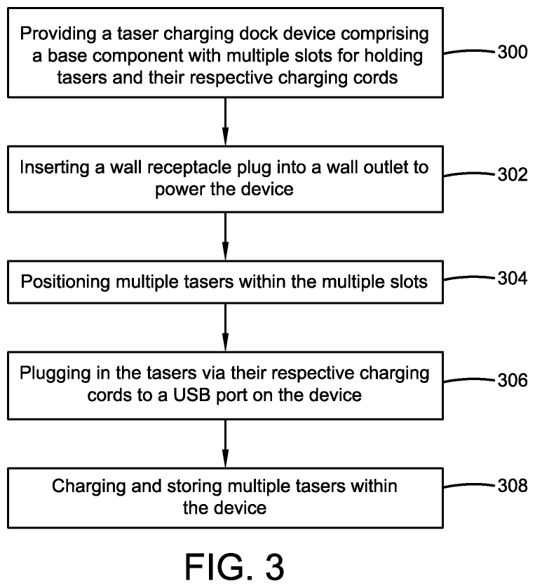

FIG. 3 illustrates a flowchart of the method of storing and charging multiple tasers simultaneously. The method includes the steps of at 300, providing a taser charging dock device comprising a base component with multiple slots for holding tasers and their respective charging cords. The method also comprises at 302, inserting a wall receptacle plug on the device into a wall outlet to power the device. Further, the method comprises at 304, positioning multiple tasers within the multiple slots. The method comprises at 306, plugging in the tasers via their respective charging cords to a USB port on the device. Finally, the method comprises at 308, charging and storing the multiple tasers in the device.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “taser charging dock device”, “taser device”, “charging dock device”, and “device” are interchangeable and refer to the taser charging dock device 100 of the present invention.

Notwithstanding the foregoing, the taser charging dock device 100 of the present invention can be of any suitable size and configuration as is known in the art without affecting the overall concept of the invention, provided that it accomplishes the above stated objectives. One of ordinary skill in the art will appreciate that the taser charging dock device 100 as shown in FIGS. 1-3 is for illustrative purposes only, and that many other sizes and shapes of the taser charging dock device 100 are well within the scope of the present disclosure. Although the dimensions of the taser charging dock device 100 are important design parameters for user convenience, the taser charging dock device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A taser charging dock device that provides a user with a specialized storage stand and charging dock for multiple electronic weapons, the taser charging dock device comprising:
a base component; and
a power source;
wherein the base component retains a plurality of electronic weapons for charging; and
further wherein the base component comprises the power source, which allows the plurality of electronic weapons to be charged simultaneously in the base component.

2. The taser charging dock device of claim 1, wherein the plurality of electronic weapons comprise a taser, a stun gun, or an electroshock weapon.

3. The taser charging dock device of claim 2, wherein the base component is generally rectangular in shape and comprises a top surface, a bottom surface, opposing front and back sides, and opposing right and left sides.

4. The taser charging dock device of claim 3, wherein the base component comprises at least one support coupled to an inner wall for supporting the plurality of electronic weapons in an upright position.

5. The taser charging dock device of claim 4, wherein the at least one support and the inner wall create a slot for retaining one of the plurality of electronic weapons in an upright position.

6. The taser charging dock device of claim 3, wherein the base component comprises a plurality of shallow apertures that are sized and shaped to retain a handle of each of the plurality of electronic weapons for charging.

7. The taser charging dock device of claim 6, wherein the handle of each of the plurality of electronic weapons is nested within the plurality of shallow apertures, to retain the plurality of electronic weapons on the base component.

8. The taser charging dock device of claim 7, wherein the plurality of electronic weapons are stored within the base component and their mating connectors are hidden within the base component.

9. The taser charging dock device of claim 8, wherein the base component comprises a charging connector component which contacts the mating connectors of the plurality of electronic weapons to charge them.

10. The taser charging dock device of claim 9, wherein the charging connector component is a 10-port USB strip to accommodate all of the plurality of electronic weapons simultaneously.

11. The taser charging dock device of claim 10, wherein the charging connector component is in electrical communication with a power source, such as an electrical plug that is plugged into a wall outlet.

12. The taser charging dock device of claim 11, wherein the power source is a battery.

13. A taser charging dock device that provides a user with a specialized storage stand and charging dock for multiple electronic weapons, the taser charging dock device comprising:
a base component that is generally rectangular in shape and comprises a top surface, a bottom surface, opposing front and back sides, and opposing right and left sides; and
a power source;
wherein the base component retains a plurality of electronic weapons for charging;
wherein the base component comprises a plurality of shallow apertures that are sized and shaped to retain a handle of each of the plurality of electronic weapons for charging;
wherein the handle of each of the plurality of electronic weapons is nested within the plurality of shallow apertures, to retain the plurality of electronic weapons on the base component;
wherein the plurality of electronic weapons are stored within the base component and their mating connectors are hidden within the base component;
wherein the base component comprises a charging connector component which contacts the mating connectors of the plurality of electronic weapons to charge them; and
further wherein the base component comprises the power source, which allows the plurality of electronic weapons to be charged simultaneously in the base component.

14. The taser charging dock device of claim 13 further comprising a plurality of indicia.

15. The taser charging dock device of claim 13, wherein the charging connector component is a 10-port USB strip to accommodate all of the plurality of electronic weapons simultaneously.

16. The taser charging dock device of claim 15, wherein the charging connector component is in electrical communication with a power source, such as an electrical plug that is plugged into a wall outlet.

17. The taser charging dock device of claim 16, wherein the power source is a battery.

18. The taser charging dock device of claim 13, wherein the plurality of electronic weapons comprise a taser, a stun gun, or an electroshock weapon.

19. The taser charging dock device of claim 13, wherein the base component comprises at least one support coupled to an inner wall which create a slot for retaining one of the plurality of electronic weapons in an upright position.

20. A method of storing and charging multiple tasers simultaneously, the method comprising the following steps:
providing a taser charging dock device comprising a base component with multiple slots for holding tasers and their respective charging cords;
inserting a wall receptacle plug on the device into a wall outlet to power the device;
positioning multiple tasers within the multiple slots;
plugging in the tasers via their respective charging cords to a USB port on the device; and
charging and storing the multiple tasers in the device.
